(19) United States
(12) Patent Application Publication
(10) Pub. No.: US 2018/0068077 A1
(43) Pub. Date: Mar. 8, 2018

(54) SYSTEM AND RELATED METHOD FOR EMERGENCY AMBULANCE DISPATCH AND TRACKING

(71) Applicant: SMart EMS LLC, Brooklyn, NY (US)

(72) Inventors: Ben SCHAPIRO, Brooklyn, NY (US); Martin FINK, Lakewood, NJ (US)

(21) Appl. No.: 15/256,525

(22) Filed: Sep. 3, 2016

(51) Int. Cl. G06F 19/00; H04L 29/08; H04L 12/58; G08B 27/00; G08G 1/127

(52) U.S. Cl. CPC G06F 19/327; H04L 67/02; H04L 67/306; H04L 51/04; H04W 4/22; G08G 1/127; G06F 19/322; G06F 19/3418; G08B 27/001

(57) ABSTRACT

A system and related method for monitoring and dispatching an emergency ambulance to a registered user including a registration database network accessed by a user through a web-based platform permitting the user to input a personal profile to become a registered user; an emergency ambulance transmitter configured to generate an emergency ambulance to the registered user requesting one; a central dispatch processor in network communication to the registration database network and emergency ambulance transmitter, wherein the central dispatch processor is configured to locate and dispatch an emergency ambulance closest to the registered user; and a tracking transmitter configured to transmit ambulance arrival time and information to the registered user and their pre-set emergency contacts.

This application claims the benefit of U.S. provisional application No. 62/214,863 filed Sep. 4, 2015 which is incorporated herein in its entirety by reference.

### FIELD OF THE INVENTION

The present invention relates to a system and method for emergency ambulance dispatch. In particular, the invention relates a system and method for an individual to easily request and track an ambulance in the event of an emergency, as well as to immediately notify users pre-set emergency contacts of the emergency event.

### BACKGROUND OF THE INVENTION

The 911 system is a long winded and bureaucratic and the individual is transferred multiple times. For example in New York City, when an individual calls 911, they are first connected to the police Department Call Receiving Operator who asks several questions. They are then transferred to a Fire Department Call Receiving Operator who asks additional questions, then they are finally transferred to the Bureau of EMS Call Receiving Operator who asks even more questions and only then is an ambulance finally dispatched. Precious lifesaving time is wasted during this process.

In addition, patients generally cannot choose which hospital they are taken to since the ambulance dispatched will take them to the closest hospital.

After the call to the ambulance has ended, the patient is in the dark of when assistance will arrive. Other than life-threatening situations, in which the next of kin is notified, family and others are not immediately notified.

With the current 911 system the upon arrival at the scene, the EMS crew has no medical history, allergies, preferred hospital and emergency contact information of the patient they have come to treat.

Family or friends from different counties, cities, states, or countries are unable to reach a 911 dispatcher without having to call someone in that region.

Various solutions to some of these issues have been proposed in the prior art. Representative patents include U.S. Pat. No. 9,237,243 to Jensen which discloses a method and system for emergency service contact alerting; U.S. Pat. No. 9,104,999 which discloses an outage schedule management apparatus and method in EMS; U.S. Pat. No. 8,896,435 to Philip et al which discloses a monitoring service that allows flexible response through operators to manage alarm conditions for a particular user; U.S. Pat. No. 8,768,292 to Welch which discloses devices, systems and methods for responding to emergency situations of infants, children and pets left unattended in a vehicle; U.S. Pat. No. 8,612,131 to Gutierrez et al. discloses an emergency and traffic alert system to navigational devices; U.S. Pat. No. 6,642,844 to Montague which discloses a dispatcherless communication system for emergency notification of emergency events; U.S. Pat. No. 6,594,634 to Hampton et al. which discloses an event reporting program to reconstruct events occurring during an emergency incident; and U.S. Pat. No. 6,130,626 to Kane et al. which discloses a mobile unit support system. However, none of these representative patents provide a system or method for dispatching and tracking an ambulance by a registered user.

With the invention system none of the problems described above exist. The invention system lets people prepare themselves before an emergency occurs. In the event of a medical emergency, an ambulance is alerted with the touch of a button. The invention system will automatically route the nearest ambulance to the call. The invention is a simple to use app that enables anyone to easily and intuitively choose the hospital they are taken to in the event of an emergency, while also notifying their loved ones. People can pre-register their preferred doctors, hospitals, medical history, allergies, and emergency contacts along with any other important information before an emergency takes place. Having this information in advance will allow our state certified emergency personnel to quickly provide them with the medical attention they require. The invention allows the patient and their emergency contacts to easily track the location and estimated time of arrival of the ambulance to know when assistance will approximately be arriving. Similar to many other industries, the medical transport industry will finally be able to give consumers what they want most, the freedom to be in control.

Since emergency events can be life threatening with time of the essence, the invention also provides a back up option to the old fashion way of calling for a 911 Emergency Ambulance. By pre-registering and using the invention system to call for the emergency ambulance, the patient's location, medical history, allergies, preferred hospital and doctor and emergency contact information are all known already. The patient and emergency contacts get an estimated time the ambulance will arrive. Additionally, the emergency contacts will get updates as to when the patient arrives at the hospital and to which hospital they were transported to. All in all this process stream lines and reduces response times to get the patient to the hospital as quickly as possible.

An advantage of the present invention system is to provide the individual with a means to easily request and ambulance in the event of an emergency.

Another advantage of the invention is to bring the individual to their hospital of choice to get the best possible care in the event of an emergency.

Another advantage of the invention is to provide the patient with an estimated time of arrival of the ambulance.

Yet another advantage of the invention is to allow the individual to track the ambulance and notifies your family members when the ambulance arrives at the home and when you reach the hospital.

### SUMMARY OF THE INVENTION

In the present invention, these purposes, as well as others which will be apparent, are achieved generally by a computer-implemented method for providing emergency ambulance dispatch to a user of a computing device, the method comprising pre-registering the user personal information including hospitals of choice, family members and medical history on a web-based platform; accessing the web-based platform during an emergency and sending message to a central dispatch for an ambulance; matching users location with closest ambulance; dispatching ambulance and providing driver with user's pre-registration personal information; tracking by user and family members for ambulance arrival time, hospital arrival time and updates.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 illustrates the general steps of the invention method;

FIG. 2 illustrates the invention system; and

FIG. 3 illustrates the invention method and system as used on a smart cell phone.

### DETAILED DESCRIPTION OF THE INVENTION

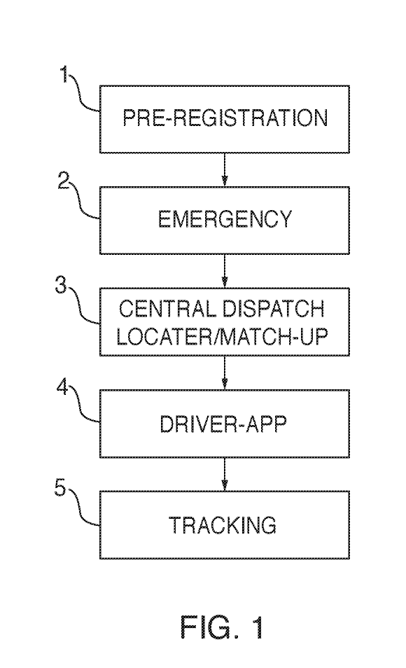

In accordance with the invention, and as illustrated in FIG. 1, a method is provided for dispatching and tracking an emergency ambulance to a registered user.

To become a registered user, in Step 1, the user must pre-register prior to an emergency. Using a web-based platform which can be accessed using a computer or cell phone, the user inputs their personal information which is stored on a database network server. In this pre-registration step the individual user can pre-select the hospital of choice in the event of an emergency and when needed, the ambulance will take them directly to their preferred hospital. The individual is able to pre-register their medical history, allergies, emergency contacts and other important information before an emergency takes place. Having this information in advance allows state certified emergency personnel to quickly provide the individual with the medical attention they require.

Once pre-registered, the user is now a registered user and it only takes one touch to get the help needed in the event of an emergency. Step 2 in FIG. 1 is when an emergency arises. The user logs into the web-based platform via any computer or cell phone device and a “Get An Ambulance Now” button appears. With one touch an ambulance with state certified emergency personnel are headed directly to the user's location. By pressing this button the user transmits a message to a central dispatch processor for an ambulance. In an alternate back up embodiment, the user can be connected to a live dispatcher.

In Step 3, Central Dispatch finds out the users location and matches the location with the closest ambulance. In a preferred embodiment this process is automated. This can also be done manually, typically by a board that lights up to show the location of the ambulance vehicles. The dispatcher assesses the emergency to dispatch the closest ambulance with emergency medical technicians (“EMT”) and/or paramedics. The next of kin, listed during the pre-registration, is notified of the emergency situation and related details.

In Step 4 once the nearest ambulance is matched and located, the selected ambulance driver is dispatched and provided with the user's personal pre-registered information, including medical history. This is typically through a Driver's App on the web-based platform and provides the EMT and/or paramedics with potentially life-saving information before they even see the patient.

As soon as the ambulance is contacted, notifications are automatically sent to all of the user's pre-set emergency contacts including family members, doctors, friends, etc, via text message and email to inform them of the user's emergency event and to which hospital the user is being taken too.

The invention allows the user, and emergency contacts, to track the exact location of the ambulance and see when it will be arriving to pick up the user and when it will be arriving at the hospital. The system provides easy tracking of the ambulance with clear, easy-to-understand information on location route and arrival times.

As a backup and alternative, the user has the ability to speak to a live dispatcher at anytime.

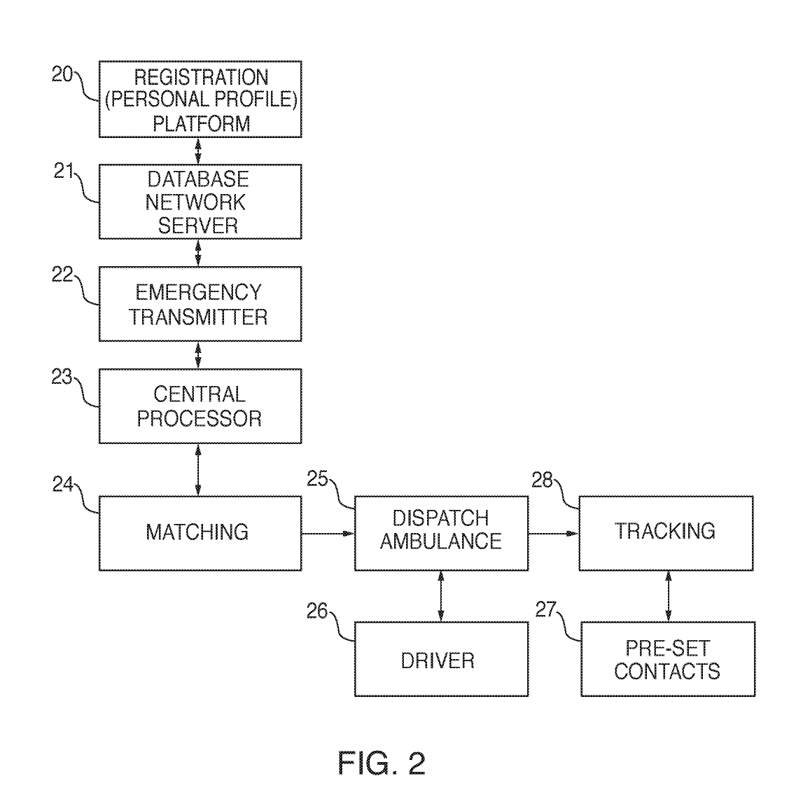

The system according to the invention for monitoring and dispatching an emergency ambulance to a registered user is illustrated in FIG. 2. A registration database network server 20 is provided which is accessed by a user through a web-based platform 21 permitting the user to input a personal profile to become a registered user. The user's personal profile includes the user's hospitals of choice, family members, medications and medical history.

The system provides the user to pre-set emergency contacts during registration to include family members, doctors, friends, next of kin and others.

An emergency ambulance transmitter 22 is provided and configured to generate an emergency ambulance to the registered user requesting one. With one touch an ambulance with EMT personnel are directed to the user's location.

A central dispatch processor 23 is in network communication to the registration database network server 21 and the emergency ambulance transmitter 22. The central dispatch processor 23 is configured to locate, match 24 and dispatch 25 an emergency ambulance closest to the registered user. The central dispatch processor assesses the emergency to dispatch the closest ambulance with EMT and/or paramedics.

A tracking transmitter 28 is provided and configured to transmit ambulance arrival time and information to the registered user. The user and the pre-set contacts can track the exact location of the ambulance and is notified when it will be arriving to pick up the user and when the user will be arriving at the hospital.

The driver of the ambulance dispatched to the user is provided with the user's personal profile 26. The user's personal profile is provided prior to the user being picked up with potentially life-saving information before the user is even seen.

The system further provides automatically notifying all pre-set emergency contacts as soon as an ambulance is dispatched 27. The pre-set emergency contacts are sent a text message and/or email to notify the contacts of the user's emergency event and which hospital they have been taken too.

The invention allows registered users to easily request an ambulance in the event of an emergency. Unlike 911, which may not bring the user to the hospital of choice, the invention system allows the user and their loved ones to choose which hospital they are taken to, to get the best possible care in the event of an emergency. The invention allows the user to track the ambulance and notifies the user's pre-selected contacts when the ambulance arrives at the user's home and when the user arrives at the hospital. The invention system and method can be accessed via a web-based platform using a computer or smart cell phone technology.

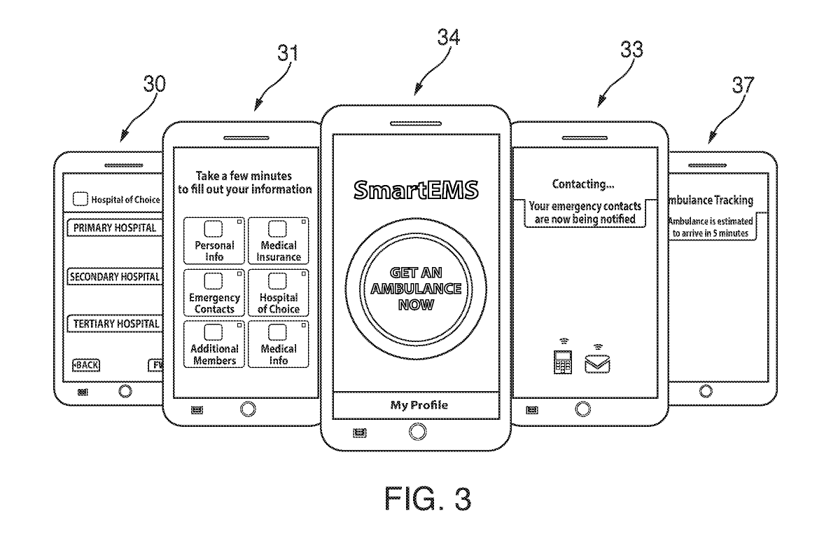

FIG. 3 illustrates the invention method and system as used on a smart cell phone. The user accesses the system registers their personal information using a web-based platform. The user pre-selects the hospital of their choice. in the event of an emergency an ambulance will take the user directly to their preferred hospital. As shown in the screen shot 30 the hospital of choice includes primary as well as secondary and tertiary hospitals, along with their addresses.

Screen shot 31 illustrates the user's pre-registration screen including personal information, medical insurance, emergency contacts, hospital of choice, additional members and medical information. This information is all collected and in place prior to an emergency. Having this information in advance permits the emergency personnel to quickly provide the user with immediate medical attention needed.

Screen shot 32 illustrates the one touch “Get an Ambulance Now” button. All it takes for the user is one touch to get help. With one touch an ambulance with state certified emergency personnel is headed directly to the user's location.

Screen shot 33 illustrates that as soon as an ambulance is contacted, notifications are automatically sent to all of the user's pre-set emergency contacts, family members, doctors, friends, etc via text message and/or email to inform them of the user's emergency event and which hospital the user was taken too.

Screen shot 34 illustrates the ambulance tracking. This feature permits the user to track the exact location of their contacted ambulance to see when it will be arriving to pick them up. It provides easy tracking of the ambulance with clear, easy to understand information on location, route and arrival times. The user's pre-set contacts also have access to this tracking information so they will know when the user has been picked up and when the will arrive at the hospital.

The invention provides an advantage and benefit over known technology. Pre-registration of the user's medical history and insurance provides quick access to first responders so that treatment can be personalized quickly in case of an emergency. Automatically contacting the user's pre-set contacts keeps the user's loved ones immediately notified of the user's emergency event.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A method for dispatching and tracking an emergency ambulance to a registered user comprising:
pre-registering the user's personal information using a web-based platform and storing the registered user's personal information on a database network server;
accessing the web-based platform during an emergency such that a registered user transmits a message to a central dispatch processor for an ambulance;
matching said user location with an emergency ambulance closest to said user;
dispatching the ambulance; and
tracking by said registered user for the ambulance arrival time, hospital arrival time and updates.

2. The method according to claim 1, wherein said personal information includes the users hospitals of choice, family members, medications and medical history.

3. The method according to claim 1, wherein the driver of the ambulance dispatched to the user is provided with the user's personal information.

4. The method according to claim 3, wherein the user's personal information is provided prior to the user being picked up with potentially life-saving information before the user is even seen.

5. The method according to claim 1, further including pre-set emergency contacts including family members, doctors, friends, next of kin and others that user has input during registration.

6. The method according to claim 5, further comprising automatically notifying all pre-set emergency contacts as soon as an ambulance is dispatched.

7. The method according to claim 6, wherein said pre-set emergency contacts are sent a text message and/or email to notify the contacts of the user's emergency event and which hospital they have been taken too.

8. The method according to claim 1, wherein said central dispatch processor assesses the emergency to dispatch the closest ambulance with EMT and/or paramedics.

9. The method according to claim 1, wherein said user can track the exact location of the ambulance and is notified when it will be arriving.

10. The method according to claim 1, wherein the user logs into the web-based platform and with one touch an ambulance with emergency personnel is directed to the user's location.

11. A system for monitoring and dispatching an emergency ambulance to a registered user comprising:
a registration database network accessed by a user through a web-based platform permitting the user to input a personal profile to become a registered user;
an emergency ambulance transmitter configured to generate an emergency ambulance to the registered user requesting one;
a central dispatch processor in network communication to said registration database network and said emergency ambulance transmitter, wherein said central dispatch processor is configured to locate, match and dispatch an emergency ambulance closest to said registered user; and
a tracking transmitter configured to transmit ambulance arrival time and information to said registered user.

12. The system according to claim 11, wherein said personal profile includes the user's hospitals of choice, family members, medications and medical history.

13. The system according to claim 11, wherein the driver of the ambulance dispatched to the user is provided with the user's personal profile.

14. The system according to claim 13, wherein the user's personal profile is provided prior to the user being picked up with potentially life-saving information before the user is even seen.

15. The system according to claim 11, further including pre-set emergency contacts including family members, doctors, friends, next of kin and others that user has input during registration.

16. The system according to claim 15, further comprising automatically notifying all pre-set emergency contacts as soon as an ambulance is dispatched.

17. The system according to claim 15, wherein said pre-set emergency contacts are sent a text message and/or email to notify the contacts of the user's emergency event and which hospital they have been taken too.

18. The system according to claim 11, wherein said central dispatch processor assesses the emergency to dispatch the closest ambulance with EMT and/or paramedics.

19. The system according to claim 11, wherein said user can track the exact location of the ambulance and is notified when it will be arriving.

20. The system according to claim 11, wherein with one touch an ambulance with EMT personnel are directed to the user's location.
